(19) United States
(12) Patent Application Publication
(10) Pub. No.: US 2025/0090878 A1
(43) Pub. Date: Mar. 20, 2025

(54) LIFELINE DEPLOYMENT LIMITER FOR SELF-RETRACTING LIFELINE

(71) Applicant: Honeywell Safety Products USA Inc., Charlotte, NC (US)

(72) Inventors: Juan Carlos Adib Audelo, Mexico City (MX); Jorge Ali Rivera Martinez, Mexico State (MX)

(21) Appl. No.: 18/368,892

(22) Filed: Sep. 15, 2023

(51) Int. Cl. A62B 35/00

(52) U.S. Cl. CPC A62B 35/0043; A62B 35/0093

(57) ABSTRACT

A system is disclosed. The system comprises a self-retracting lifeline having at least one sensor configured to measure distance parameter with respect to a position of the self-retracting lifeline. A device coupled operationally with the self-retracting lifeline, having a processor and a memory configured to store instructions which when executed by the processor causes the processor to receive the distance parameter with respect to the position of the self-retracting lifeline; determine a lifeline extension limit based on the distance parameter; and execute one or more operations upon reaching the lifeline extension limit, for a safety event. The one or more operations comprise at least one of applying a brake to the self-retracting lifeline and/or triggering an alarm.

### FIELD OF THE DISCLOSURE

An example embodiment relates generally to fall protection systems and, more particularly, to a lifeline deployment limiter for a self-retracting lifeline.

### BACKGROUND OF THE DISCLOSURE

Fall protection devices play a crucial role in ensuring safety of workers, particularly those engaged in tasks at elevated heights, such as in construction. The fall protection devices such as safety harnesses, lanyards, energy absorbers, self-retracting lifelines (SRLs), descenders, and similar equipment, are employed to minimize the risk of injuries resulting from falls. The SRLs, for instance, consist of a housing connected to a biased drum, which houses a lifeline. The lifeline extends and retracts from the housing, causing the drum to rotate accordingly. The SRLs integrate multiple sensors for measuring parameters such as lifeline speed, length, and acceleration. Such integration of multiple sensors predicts an occurrence of safety events like falls or the need for maintenance. However, the existing SRLs lack a feature that allows the user to limit the extension of the lanyard themselves, thereby defining a specific working distance to mitigate the risk of a fall event.

Applicant has identified various issues and challenges associated with current fall protection and locking devices. However, with creativity, hard work, and innovation, the present disclosure has addressed many of these problems through its methods and equipment.

### SUMMARY OF THE DISCLOSURE

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a system is disclosed. The system comprises a self-retracting lifeline having at least one sensor configured to measure distance parameter with respect to a position of the self-retracting lifeline. Further, the system comprises a device coupled operationally with the self-retracting lifeline, having a processor and a memory configured to store instructions which when executed by the processor causes the processor to: receive the distance parameter with respect to the position of the self-retracting lifeline; determine a lifeline extension limit based on the distance parameter; and execute one or more operations upon reaching the lifeline extension limit, for a safety event. The one or more operations comprise at least one of applying a brake to the self-retracting lifeline and/or triggering an alarm.

In some embodiments, the at least one sensor comprises at least one of a laser measurement unit configured to determine the distance parameter having a fall clearance distance and a safety working distance; and an odometer configured to determine extension of a lifeline cable from the self-retracting lifeline based on the distance parameter.

In some embodiments, the fall clearance distance is the distance from a position of the self-retracting lifeline to a next ground level, and the safety working distance is the distance from the position of the self-retracting lifeline to a working surface. In some embodiments, the lifeline extension limit corresponds to a maximum allowance limit of the lifeline cable.

In some embodiments, the system comprises a communication unit configured to transmit a notification to a user, upon reaching the lifeline extension limit and a reset unit configured to reset configuration, related to the distance parameter and the lifeline extension limit, after the completion of each operation of the self-retracting lifeline.

In another example embodiment, a self-retracting lifeline is disclosed. The self-retracting lifeline comprises a drum having a locking gear and a lifeline cable wound around the drum. Further, the self-retracting lifeline comprises at least one sensor configured to measure distance parameter with respect to a position of the self-retracting lifeline. Further, the self-retracting lifeline comprises a processor configured to receive the distance parameter with respect to the position of the self-retracting lifeline; determine a lifeline extension limit based on the distance parameter; and actuate a drum stopper to apply brake to the lifeline cable, via the locking gear, upon reaching the lifeline extension limit, for a safety event.

In some embodiments, the at least one sensor comprises at least one of a laser measurement unit configured to determine the distance parameter having a fall clearance distance and a safety working distance; and an odometer configured to determine extension of a lifeline cable from the self-retracting lifeline based on the distance parameter.

In some embodiments, the fall clearance distance is the distance from a position of the self-retracting lifeline to a next ground level, and the safety working distance is the distance from the position of the self-retracting lifeline to a working surface. In some embodiments, the lifeline extension limit corresponds to a maximum allowance limit of the lifeline cable.

In another example embodiment, a device is disclosed. The device comprises at least one strap for coupling to a self-retracting lifeline. The device further comprises at least one sensor configured to measure distance parameter with respect to a position of the self-retracting lifeline. The device further comprises a processor that is configured to receive the distance parameter with respect to the position of the self-retracting lifeline; determine a lifeline extension limit based on the distance parameter; and trigger an alarm upon reaching the lifeline extension limit, for a safety event.

In some embodiments, the device further comprises at least one slot configured to receive a lifeline cable of multiple profiles, and a display unit configured to display the distance parameter and the lifeline extension limit.

In some embodiments, the device further comprises a communication unit configured to transmit a notification to a user, based upon the triggering of the alarm, and a reset unit configured to reset configuration, related to the distance parameter and the lifeline extension limit, after each operation of the self-retracting lifeline.

In some embodiments, the at least one sensor comprises a laser measurement unit configured to determine the distance parameter having a fall clearance distance and a safety working distance; and an odometer configured to determine extension of a lifeline cable from the self-retracting lifeline based on the distance parameter.

In another example embodiment, a method is disclosed. The method comprising steps of obtaining, via at least one sensor, a first distance. The first distance is the distance from a position of a self-retracting lifeline to a next ground level. Further, the method includes obtaining, via the at least one sensor, a second distance. The second distance is the distance from the position of the self-retracting lifeline to a working surface. Further, the method comprises determining a lifeline extension limit of the lifeline cable based at least on the obtained first distance and the second distance. In some embodiments, the lifeline extension limit is determined by a difference between the first distance and the second distance. Thereafter, the method includes executing one or more operations upon reaching the lifeline extension limit, for a safety event. The one or more operations comprise at least one of applying a brake to the lifeline cable or triggering an alarm.

In some embodiments, the method further comprises transmitting, via a communication unit, a notification to the user, based upon reaching the lifeline extension limit. The lifeline extension limit corresponds to a maximum allowance limit of the lifeline cable.

In some embodiments, the method further comprises actuating a drum stopper to apply brake to the lifeline cable upon reaching the lifeline extension limit, for the safety event.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIGS. 1A-1C illustrate a self-retracting lifeline (SRL) system, in accordance with the present disclosure;

FIG. 2 is a perspective view of the SRL attached to a user via a harness, in accordance with the present disclosure;

FIGS. 3A-3B illustrate front views of an internal mechanism of the SRL, in accordance with the present disclosure;

FIG. 4 illustrates a perspective view of a device for coupling with the SRL, in accordance with the present disclosure;

FIG. 5 illustrates a perspective view of the device coupled with the SRL using at least one strap, in accordance with the present disclosure;

FIGS. 6A-6F illustrate a working operation of the SRL system, in accordance with the present disclosure; and

FIG. 7 is a flowchart showing steps for a method of operating the self-retracting lifeline (SRL) system, in accordance with the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to impede a lifeline further than a clearance distance to prevent an accident.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

Various embodiments allow a self-retracting lifeline (SRL) system to incorporate one or more electronic sensors for capturing data that is indicative of operation, location, or environmental conditions surrounding the SRL. Such data may generally be referred to herein as usage data or, alternatively, sensor data. Usage data may take the form of a stream of samples over a period of time. In some instances, the electronic sensors may be configured to measure length, speed, acceleration, force, or a variety of other characteristics associated with a lifeline of the SRL, positional information indicative of the location of the SRL, and/or environmental factors associated with an environment in which the SRL is located. Moreover, as described herein, the SRL may be configured to include one or more electronic components for outputting communication to the respective worker, such as speakers, vibration devices, LEDs, buzzers or other devices for outputting alerts, audio messages, sounds, indicators and the like. Various embodiments of the present disclosure allow for locking of the lifeline cable as soon as the worker completes a certain specified safety distance defined by the SRL system to prevent occurrence of the safety event and thus improve working conditions without having continuous monitoring of the safety distance and the SRL.

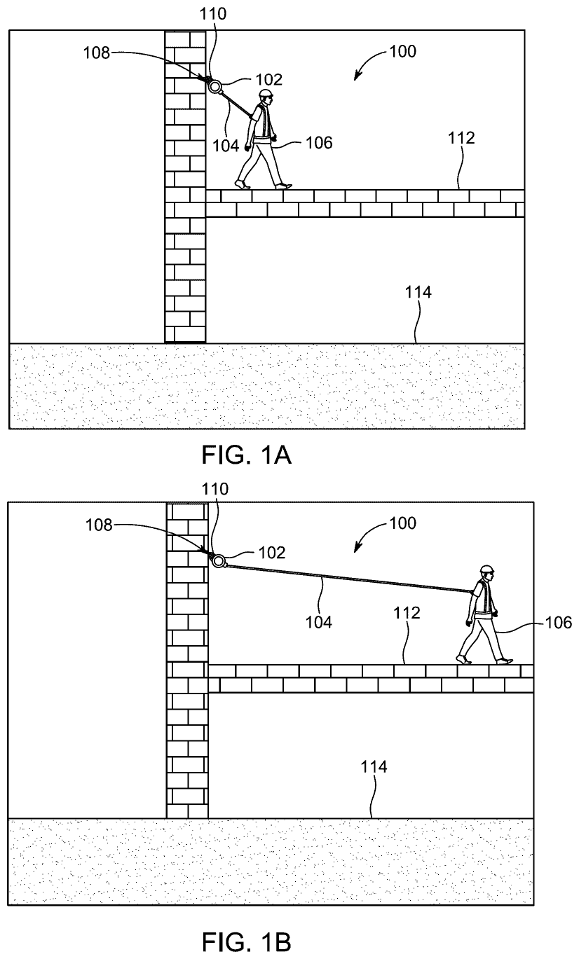

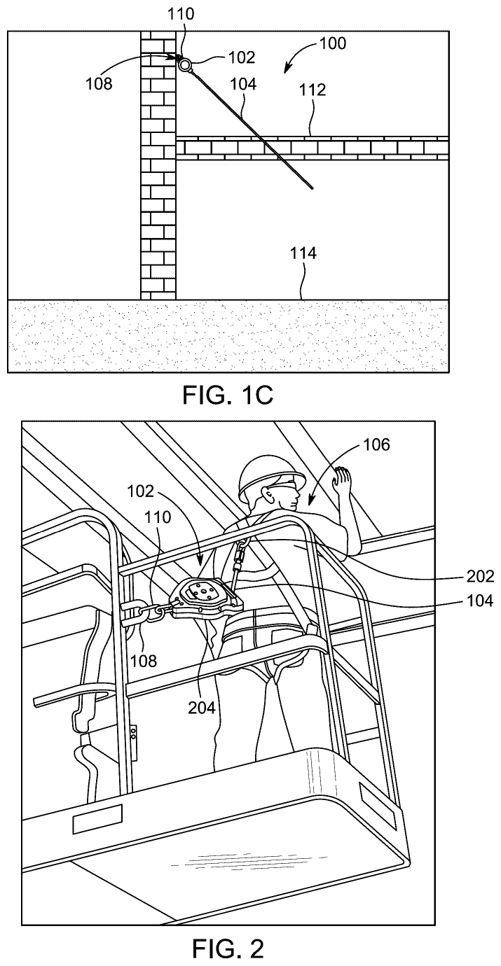

FIGS. 1A-1C illustrate a self-retracting lifeline (SRL) system 100, in accordance with the present disclosure. The SRL system 100 may be referred to as the system 100.

The system 100 may include a SRL 102 having a locking mechanism (not shown) encased within a casing (not shown). Further, the SRL 102 may include a lifeline cable 104 with one end coupled with the locking mechanism of the SRL 102 and other end connected to a harness (not shown) of a user 106. In some embodiments, the SRL 102 may be attached to an anchor point 108 via an anchor 110, as shown in FIG. 1A. The locking mechanism may lock the lifeline cable 104 upon occurrence of a safety event or fall. During the fall, the locking mechanism having a drum (not shown) with toothed gears (not shown), may engage to lock the lifeline cable 104 instantaneously. As the user 106 walks over a working surface 112 and upon occurrence of the safety event or fall, the locking mechanism may lock the lifeline cable 104 instantaneously, and thus protects the user 106 from falling on a ground i.e. next ground level 114.

FIG. 2 is a perspective view of the SRL 102 attached to the user 106 via a harness 202, in accordance with the present disclosure.

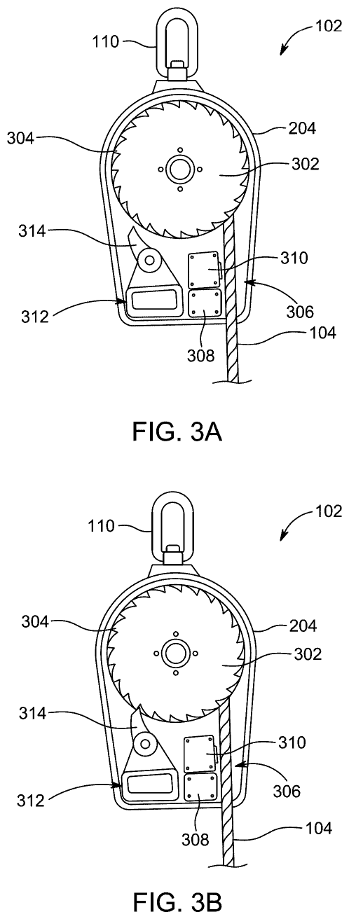

The SRL 102 may be attached to the user 106 via the harness 202 at one end and at other end, the SRL 102 may be attached to the anchor point 108 via the anchor 110. It may be noted that the anchor point 108 may be integrated onto a vertical wall or a construction frame. The SRL 102 may comprise a casing 204 enclosing a drum (not shown), one or more sensors (not shown), and a device (not shown). The drum may comprise gear tooth or a locking gear (not shown) with a drum stopper (not shown). Further, the lifeline cable 104 may be wrapped around the drum. The SRL 102 may provide a free movement for the user 106 to maintain optimum working conditions at greater heights. The SRL 102 when attached to the harness 202 via the lifeline cable 104 may enable free movement of the user 106 and thereby allow more focus on the work without having a threat of falling or an accident. The SRL 102 and its components are described later in conjunction with FIGS. 3A-3B.

FIGS. 3A-3B illustrate front views of an internal mechanism of the SRL 102, in accordance with the present disclosure. FIGS. 3A-3B are described in conjunction with FIGS. 1A-2.

The SRL 102 may be provided with the anchor 110 for anchoring or attaching the SRL 102 to the anchor point 108, as shown in FIG. 2. The SRL 102 may comprise the casing 204 enclosing a drum 302 having a locking gear 304 and the lifeline cable 104 wrapped around the drum 302. The casing 204 may be made of a material selected from a group of materials such as, but is not limited to, stainless steel, alloy steel, cast iron, nylon, or hard plastics, without departing from the scope of the disclosure. In some embodiments, the casing 204 may be of varied shapes as per the requirement or convenience of the user 106. Further, the locking gear 304 may be fabricated along a periphery of the drum 302. The locking gear 304 may correspond to a toothed gear configured to be actuated in response to an extension of the lifeline cable 104 deployed from the SRL 102.

Further, the SRL 102 may comprise at least one sensor 306 configured to measure a distance parameter with respect to a position of the SRL 102. In some example embodiments, the distance parameter may correspond to a fall clearance distance and a safety working distance. In some embodiments, the fall clearance distance may be defined as the distance from a position of the SRL 102 to the next ground level 114. In some embodiments, the safety working distance may be defined as a distance from the positon of the SRL 102 to the working surface 112. The safety working distance may also be referred as a working distance and may be used interchangeably hereinafter.

In some embodiments, the at least one sensor 306 may comprise a laser measurement unit 308 configured to capture at least the fall clearance distance and the safety working distance. The laser measurement unit 308 emits a laser beam that strikes the next ground level 114. The laser beam further reflects from the next ground level 114 and reaches back to the laser measurement unit 308. Based on the speed of the laser beam and time taken for the collection of the laser beam, the laser measurement unit 308 may result in determining the distance from the position of the SRL 102 to the next ground level 114. Similarly, the laser measurement unit 308 measures the distance from the position of the SRL 102 to the working surface 112. Further, the at least one sensor 306 may comprise an odometer 310 to determine extension of the lifeline cable 104 from the SRL 102 based on the distance parameter. In some example embodiments, the odometer 310 may correspond to an instrument to measure extension or length of the lifeline cable 104, without departing from the scope of the disclosure.

Further, the SRL 102 may comprise a processing unit 312 rotatably coupled to a drum stopper 314. The drum stopper 314 may be actuated by the processing unit 312. Further, the processing unit 312 may comprise a processor (not shown) and a memory (not shown) configured to store instructions which when executed by the processor causes the processor to perform one or more operations upon reaching the lifeline extension limit. The one or more operations may comprise at least one of applying a brake to the SRL 102 or triggering an alarm.

In some embodiments, the processor may be configured to receive the distance parameter measured by the at least one sensor 306 with respect to the position of the SRL 102. Further, the processor may be configured to determine a lifeline extension limit based on the measured distance parameter. Successively, the processor may be configured to actuate the drum stopper 314 to apply brake to the lifeline cable 104, via the locking gear 304, upon reaching the lifeline extension limit, for the safety event. In some embodiments, the processor may actuate the drum stopper 314 as soon as the user 106 reaches the lifeline extension limit measured by the odometer 310. In some embodiments, the odometer 310 may provide real-time measurement of the lifeline cable 104 extended from the SRL 102. Such real-time measurement of the lifeline cable 104 instantaneously activates the drum stopper 314 to engage with the locking gear 304 upon reaching the lifeline extension limit. Therefore, the engagement of the drum stopper 314 with the locking gear 304 blocks the drum 302 from further deployment of the lifeline cable 104. In some embodiments, the SRL 102 automatically locks the lifeline cable 104 upon reaching the lifeline extension limit, for the safety event. In some embodiments, the lifeline extension limit may be set less than the fall clearance distance, such that the user 106 upon reaching the lifeline extension limit, may not hit the next ground level 114.

In some embodiments, the processor may be an integrated electronic circuit to perform calculations that facilitates operations of the processing unit 312. The processor may perform arithmetical, logical, input/output (I/O) and other basic instructions. In some embodiments, the memory may be configured to store information related to the distance parameter and the extension of the lifeline cable 104 measured by the odometer 310. Further, the memory may be configured to store instructions for the processor which may be executed by the processor to perform the one or more operations based on the information stored in the memory.

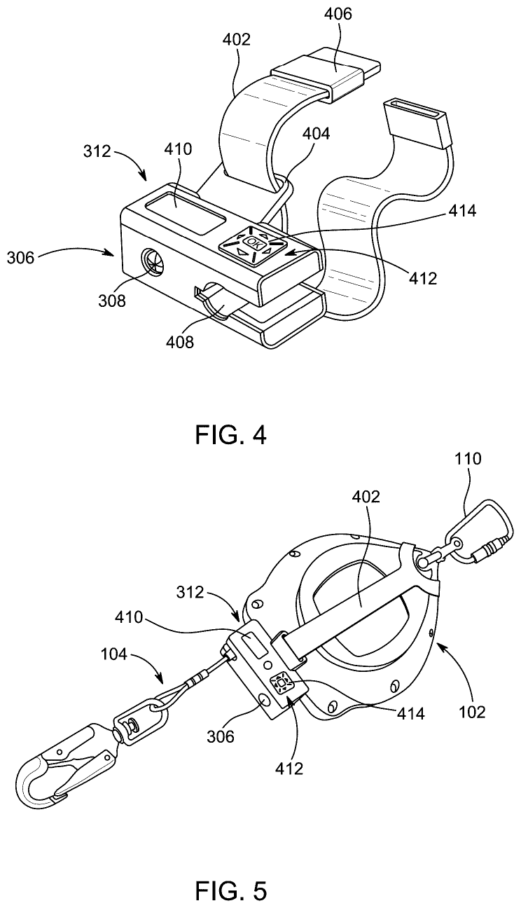

In some embodiments, the SRL 102 may comprise a device (not shown) having a communication device (not shown) configured to transmit a notification to the user 106, upon reaching the lifeline extension limit. In some embodiments, the device may be integrated within the SRL 102. In some embodiments, the device may be attached as a separate unit to the SRL 102. The device is described in greater detail in conjunction with FIGS. 4-5 of the detailed description.

Referring to FIGS. 4-5, a device 400 is disclosed, in accordance with the present disclosure. FIGS. 4-5 are described in conjunction with FIGS. 1A-3B.

The device 400 may comprise at least one strap 402 for coupling to the SRL 102. Further, the device 400 may comprise the at least one sensor 306 configured to measure the distance parameter with respect to the position of the SRL 102, as discussed above. Further, the device 400 may comprise attachment slots 404 integrated on the device 400 to receive the at least one strap 402. In some embodiments, the at least one strap 402 may be an elastic band with a locking attachment 406, to conveniently attach the device 400 to the SRL 102.

Further, the device 400 may be integrated with at least one slot 408 to receive the lifeline cable 104 of multiple profiles. It may be noted that the multiple profiles of the lifeline cable 104 may vary according to jobs to be performed. For instance, jobs in structural welding (that expose the lifeline cable 104 to sharp edges) may require a thicker lifeline cable than a domestic roofing work (with no specific hazards that may damage the lifeline cable 104). Further, the device 400 may comprise a display unit 410 that is configured to display the distance parameter and the lifeline extension limit. Further, the device 400 may comprise a reset unit 412 configured to reset configuration, related to the distance parameter and the lifeline extension limit based on the measured distance parameter, after each operation of the SRL 102. In some embodiments, the reset unit 412 may be provided with multiple operational buttons 414 to set and reset the lifeline extension limit once the laser measurement unit 308 measures the distance parameter. In some example embodiments, the user 106 may input his/her height using the reset unit 412, when the SRL 102 is anchored at a level of the working surface 112. Such addition of the height may be taken into consideration as the distance from the SRL 102 to the working surface 112. In some embodiments, the reset unit 412 may be used to reset the configuration once the operation of the SRL 102 is complete, so that for a next operation a different distance parameter measured and a different lifeline extension limit is defined. Therefore, the reset unit 412 may prevent the user 106 from using an incorrect distance when the user 106 changes the location. In some embodiments, the reset unit 412 may be configured to start operation of the SRL 102, by pushing one of the multiple operational buttons 414, and thereafter the laser measurement unit 308 may start determining the distance parameter with respect to the position of the SRL 102.

In some embodiments, the device 400 may be embedded with the communication unit that is configured to transmit the notification to the user 106, upon reaching the lifeline extension limit, for the safety event. In some exemplary embodiments, the communication unit may be a speaker or a buzzer of specific intensity to be heard by the user 106. Further, the device 400 may trigger an alarm upon reaching the lifeline extension limit, for the safety event, instead of actually blocking the lifeline cable 104. The alarm may be a notification or a voice note transmitted by the communication unit to the user 106.

In some embodiments, the device 400 may comprise the processing unit 312, as described in conjunction with FIGS. 3A-3B. It will be apparent to one skilled in the art that the device 400 may be integrated within the SRL 102 or an external device coupled to the SRL 102, and include other components as well, without departing from the scope of the disclosure.

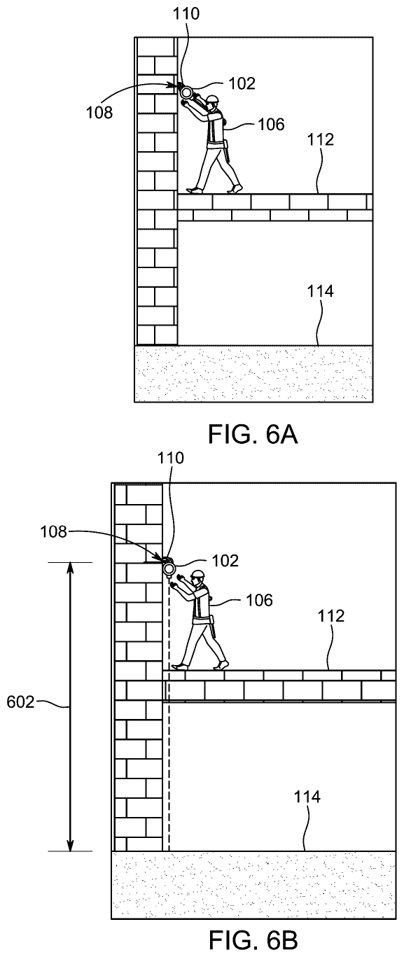

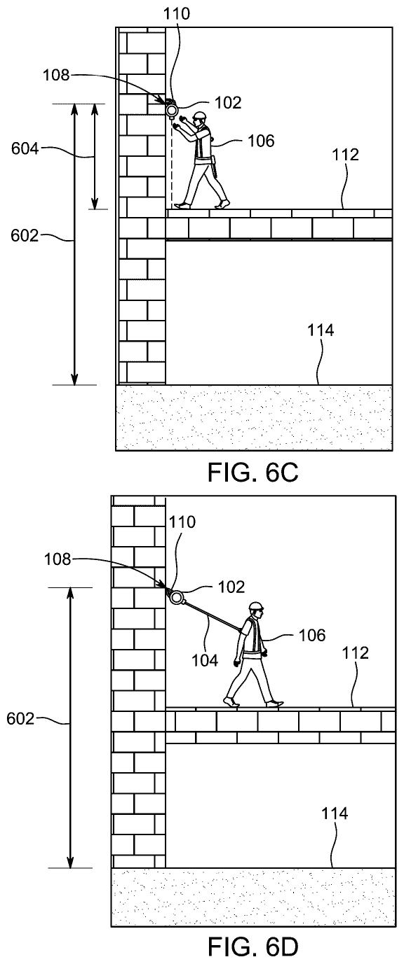

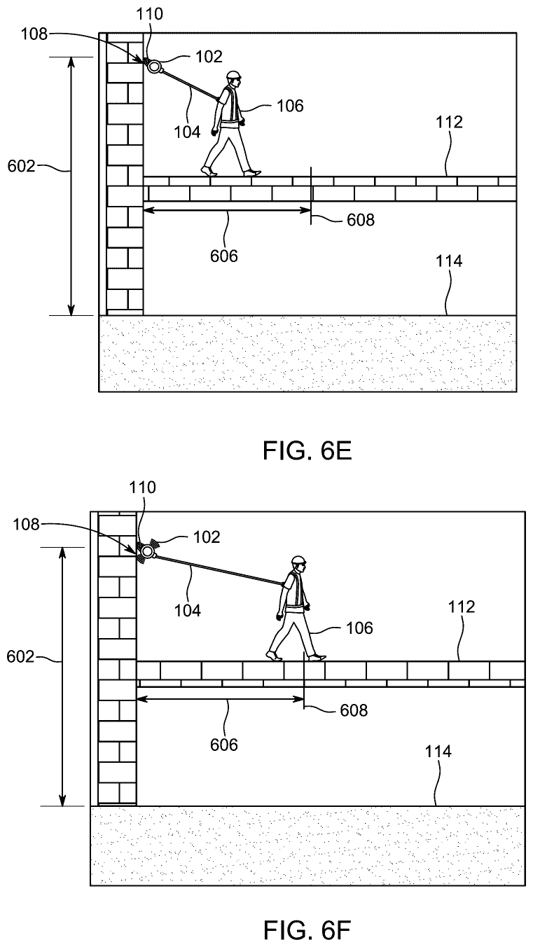

Referring to FIGS. 6A-6F, the working operation of the SRL 102 is disclosed, in accordance with the present disclosure. FIGS. 6A-6F are described in conjunction with FIGS. 1A-5.

At first, the user 106 may anchor the SRL 102 to the anchor point 108 via the anchor 110, as shown in FIG. 6A. After anchoring the SRL 102, the at least one sensor 306 within the SRL 102 may automatically start measuring the distance parameter with respect to the position of the SRL 102. In another embodiment, after anchoring the SRL 102, the user 106 may push the operational buttons 414 and the laser measurement unit 308 may start measuring the distance parameter with respect to the position of the SRL 102. As shown in FIG. 6B, a first distance 602 i.e. a fall clearance distance may be determined. The first distance 602 is the distance from a position of the SRL 102 to a next ground level 114. For example, the fall clearance distance measured is 30 meters. Successively, a second distance 604 i.e. safety working distance may be determined, as shown in FIG. 6C. The second distance 604 is the distance from the position of the SRL 102 to the working surface 112. For example, the safety working distance measured is 12 meters.

Further, the user 106 may attach the lifeline cable 104 of the SRL 102 to the harness 202 using a carabiner (not shown) or other connecting means, without departing from the scope of the disclosure. It may be noted that the harness 202 may be worn by the user 106. Thereafter, as shown in FIG. 6D, the user 106 may start walking on the walking surface 112 for performing operations such as welding beams on a structure, cleaning etc.

As discussed above, the processor may determine a lifeline extension limit 606, as shown in FIG. 6E, based on the measured distance parameter. In some embodiments, the lifeline extension limit 606 may be determined as a difference between the first distance 602 and the second distance 604. In some embodiments, the lifeline extension limit 606 may be the distance from the anchor point 108 to a working point 608. In some embodiments, the lifeline extension limit 606 may be referred as the safety working distance, as described above. For example, the lifeline extension limit 606 determined is 18 meters.

Successively, as the user 106 reaches the lifeline extension limit 606, the processor may actuate the drum stopper 314 to lock the drum 302 via the locking gear 304 and block the further deployment of the lifeline cable 104 instantaneously, as shown in FIG. 6F. The actuation of the drum stopper 314 may be performed in real-time with respect to extension of the lifeline cable 104 continuously measured by the odometer 310. In some embodiments, the processor may trigger the alarm using the device 400, to alert the user 106, that the lifeline extension limit 606 or the second distance 604 is over.

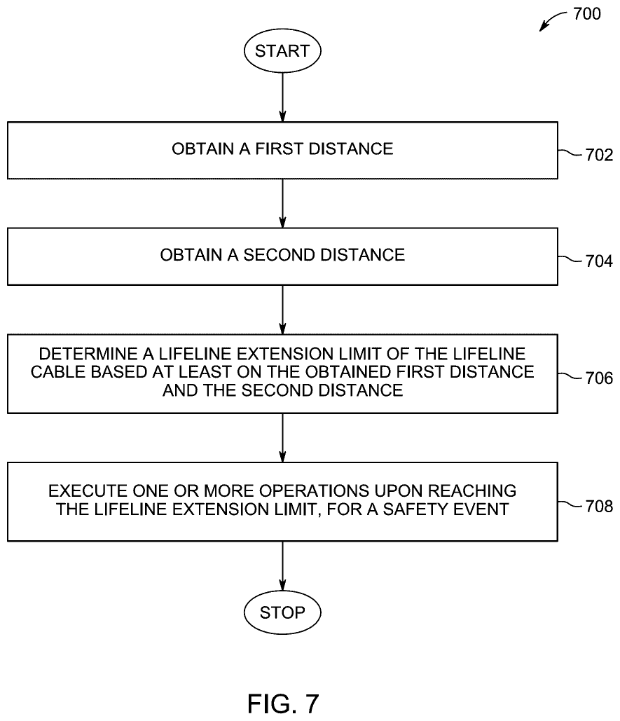

FIG. 7 is a flowchart 700 for a method of operating the SRL system 100, in accordance with the present disclosure. FIG. 7 is described in conjunction with FIGS. 1A-6F.

At first, the at least one sensor 306 may obtain the first distance 602, at step 702. The first distance 602 is the distance from the position of the SRL 102 to the next ground level 114. As discussed above, the first distance 602 may correspond to the fall clearance distance, as shown in FIGS. 6B-6F. For example, the laser measurement unit 308 measures the first distance 602 as 50 meters.

Successively, the at least one sensor 306 may obtain the second distance 604, at step 704. The second distance 604 is the distance from the position of the SRL 102 to the working surface 112. For example, the laser measurement unit 308 measures the second distance 604 as 10 meters.

Successively, the processor may determine the lifeline extension limit 606 of the lifeline cable 104 based at least on the obtained first distance 602 and the second distance 604, at step 706. In some embodiments, the lifeline extension limit 606 may be determined as the difference between the first distance 602 and the second distance 604. For example, the processor determines that the lifeline extension limit 606 is 40 meters corresponding to the first distance 602 of 50 meters and the second distance of 10 meters.

Successively, the processor may execute the one or more operations upon reaching the lifeline extension limit 606, for the safety event, at step 708. The one or more operations comprise at least one of applying a brake to the lifeline cable 104 or triggering an alarm. For example, in one case, the processor actuates the drum stopper 314 to engage with the locking gear 304 and stop further deployment of the lifeline cable 104, upon reaching the 40 meters. In another case, the processor triggers an alarm upon reaching the lifeline extension limit, for the safety event.

In some embodiments, the SRL 102 may provide varying length for the lifeline extension limit 606. In some example embodiments, the lifeline extension limit 606 may range according to a length of the lifeline cable 104 and the distance parameter. In some example embodiments, the SRL 102 may provide a range of between 3 feet to more than 200 feet for the lifeline extension limit 606. In some example embodiments, the SRL 102 provides mechanical blocking of the lifeline cable 104 and stopping the user 106, to facilitate optimum working conditions, in noisy and calm construction environments.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a self-retracting lifeline comprising at least one sensor configured to measure distance parameter with respect to a position of the self-retracting lifeline; and
a device coupled operationally with the self-retracting lifeline, having a processor and a memory configured to store instructions which when executed by the processor causes the processor to:
receive the distance parameter with respect to the position of the self-retracting lifeline;
determine a lifeline extension limit based on the distance parameter; and
execute one or more operations upon reaching the lifeline extension limit, for a safety event, wherein the one or more operations comprise at least one of applying a brake to the self-retracting lifeline or triggering an alarm.

2. The system of claim 1, wherein the at least one sensor comprises at least one of:
a laser measurement unit configured to determine the distance parameter having a fall clearance distance and a safety working distance; and
an odometer configured to determine extension of a lifeline cable from the self-retracting lifeline based on the distance parameter.

3. The system of claim 2, wherein the fall clearance distance is the distance from a position of the self-retracting lifeline to a next ground level, and the safety working distance is the distance from the position of the self-retracting lifeline to a working surface.

4. The system of claim 1, wherein the lifeline extension limit corresponds to a maximum allowance limit of the lifeline cable.

5. The system of claim 1, further comprising:
a communication unit configured to transmit a notification to the user, based upon reaching the lifeline extension limit; and
a reset unit configured to reset configuration, related to the distance parameter and the lifeline extension limit, after the completion of each operation of the self-retracting lifeline.

6. A self-retracting lifeline comprising:
a drum having a locking gear and a lifeline cable wound around the drum;
at least one sensor configured to measure distance parameter with respect to a position of the self-retracting lifeline;
a processor configured to:
receive the distance parameter with respect to the position of the self-retracting lifeline;
determine a lifeline extension limit based on the distance parameter; and
actuate a drum stopper to apply brake to the lifeline cable, via the locking gear, upon reaching the lifeline extension limit, for a safety event.

7. The self-retracting lifeline of claim 6, wherein the at least one sensor comprises at least one of:
a laser measurement unit configured to determine the distance parameter having a fall clearance distance and a safety working distance; and
an odometer configured to determine extension of the lifeline cable from the self-retracting lifeline based on the distance parameter.

8. The self-retracting lifeline of claim 7, wherein the fall clearance distance is the distance from a position of the self-retracting lifeline to a next ground level, and the safety working distance is the distance from the position of the self-retracting lifeline to a working surface.

9. The self-retracting lifeline of claim 6, wherein the lifeline extension limit corresponds to a maximum allowance limit of the lifeline cable.

10. A device comprising:
at least one strap for coupling to a self-retracting lifeline;
at least one sensor configured to measure distance parameter with respect to a position of the self-retracting lifeline;
a processor configured to:
receive the distance parameter with respect to the position of the self-retracting lifeline;
determine a lifeline extension limit based on the distance parameter; and
trigger an alarm upon reaching the lifeline extension limit, for a safety event.

11. The device of claim 10, further comprising:
at least one slot configured to receive a lifeline cable of multiple profiles; and
a display unit configured to display the distance parameter and the lifeline extension limit.

12. The device of claim 10, further comprising:
a communication unit configured to transmit a notification to a user, based upon the triggering of the alarm; and
a reset unit configured to reset configuration, related to the distance parameter and the lifeline extension limit, after each operation of the self-retracting lifeline.

13. The device of claim 10, wherein the at least one sensor comprises at least one of:
a laser measurement unit configured to determine the distance parameter having a fall clearance distance and a safety working distance; and
an odometer configured to determine extension of the lifeline cable from the self-retracting lifeline based on the distance parameter.

14. The device of claim 13, wherein the fall clearance distance is the distance from a position of the self-retracting lifeline to a next ground level, and the safety working distance is the distance from the position of the self-retracting lifeline to a working surface.

15. The device of claim 10, wherein the lifeline extension limit corresponds to a maximum allowance limit of the lifeline cable.

16. A method comprising:
obtaining, via at least one sensor, a first distance, wherein the first distance is the distance from a position of a self-retracting lifeline to a next ground level;
obtaining, via the at least one sensor, a second distance, wherein the second distance is the distance from the position of the self-retracting lifeline to a working surface;
determining a lifeline extension limit of the lifeline cable based at least on the obtained first distance and the second distance; and
executing one or more operations upon reaching the lifeline extension limit, for a safety event, wherein the one or more operations comprise at least one of applying a brake to the lifeline cable or triggering an alarm.

17. The method of claim 16, wherein the lifeline extension limit corresponds to a maximum allowance limit of the lifeline cable.

18. The method of claim 16, further comprising:
transmitting, via a communication unit, a notification to the user, based upon the reaching the lifeline extension limit.

19. The method of claim 16, further comprising:
actuating a drum stopper to apply brake to the lifeline cable upon reaching the lifeline extension limit, for the safety event.
